(19) United States
(12) Patent Application Publication
(10) Pub. No.: US 2012/0074270 A1
(43) Pub. Date: Mar. 29, 2012

(54) Combined Guitar Stand, Repair Station with Wall Mount/ Display Feature

(76) Inventor: Craig Daniel Pays, Kenner, LA (US)

(21) Appl. No.: 12/888,803

(22) Filed: Sep. 23, 2010

(51) Int. Cl. F16M 11/10; F16M 13/00

(52) U.S. Cl. 248/121

(57) ABSTRACT

A guitar support structure for standing a guitar on it's end (a basic stand), for supporting a guitar in a prone position (for repairs and service) and for displaying a guitar (via wall mount feature) or other string instrument. It can be crafted from fine wood (or plastic or metal) featuring folding support legs, dowel supports, neck cradle and separate wall bracket for wall mount display. Combined guitar stand, repair station and wall mount/display is comprised of a main plank of wood (or plastic or metal) with rear mounted support legs permanently attached by piano (or similar) type hinge. Folding support legs allow stand to lie flat (prone) on desktop or floor allowing service repairs (stringing and minor repairs). The main stand can attach to a separate wall bracket that can be mounted on a wall, thereby freeing up floor space and reducing the chance of damage.

### FIELD OF THE INVENTION

The present invention relates to a combination stand and repair station for use with a guitar or similar stringed instrument. More specifically, a guitar, banjo or stringed instrument accessory that encompasses a guitar stand and repair station and optional wall mount display in a single compact unit. The unit can be used to support the instrument, in a substantially upright position, prone, horizontal or flat. It maintains stability on a table or flat surface. It can be used to support an instrument in a lying position for changing strings or making minor repairs. The stand is able to be wall mounted to display an instrument.

### BACKGROUND OF THE INVENTION

Stringed instrument owners desire as much protection of an instrument from damage as is reasonably possible by utilizing a support accessory to prevent damage while the instrument is not stored in a case. Leaning a guitar against a wall or lying it on a floor is potentially damaging to the instrument. Performers who use several stringed instruments require a stage accessory to satisfy this need.

Stringed instrument owners have to contend with awkward maintenance tasks, such as changing strings and performing minor structural repairs, bridge repairs, pick-up repairs and controlling mechanical adjustments. The changing of strings presents a problem in that the instrument is typically laid horizontally on a flat surface. The neck and head stock must be kept relatively stable to facilitate the removal of old strings and the installation of new ones. Minor repairs, cleaning and polishing are functions that also require some stabilization of the instrument. Care must be taken not to damage delicate surfaces. A retaining device with some sort of padding of rubber or similar to protect instrument finishes is typically used.

It is desirable that such an apparatus be compact and conveniently transportable to be utilized on a stage or in a studio.

It is also desirable to have a stringed instrument stand that is pleasant to the eye that blends well with furniture and room decor even when no instrument is place thereon.

It is also desirable to have an accessory that, optionally, can be mounted on a wall or other surface. Musicians having several stringed instruments need a way to reduce clutter in work or studio areas. Substantial floor space is conserved by displaying instruments on a wall and protects instruments from damage.

Therefore, with these needs in mind, the present invention provides all of the above features in a stringed instrument accessory structure that can be easily disassembled to enable transportation and prevent damage. Traditional single function, metal stringed instrument stands generally are cumbersome, unattractive and damaging to valuable instruments.

The general purpose and feature of this invention are to address the issues of physical appearance and functionality. Specifically, by enabling more ease in the changing of strings and minor structural repairs and adjustments. The instrument gently lays on an instrument friendly surface while unemployed as well as during repairs. The general wood grain attractiveness lends itself well to living areas as well as studios and stages.

The additional wall mount feature separates this accessory from typical stringed instrument supports. The detail and beauty of vintage guitars, banjos and medium sized stringed instruments is dramatically brought out when placed at eye level. The wall mounting of multiple instruments is an elegant and impressive manner in which to display the instruments you are proud of.

### BRIEF DESCRIPTION OF THE DRAWINGS

A preferred embodiment of the present invention is described below with reference to the accompanying drawings, in which:

FIG. 1 is a perspective view of an embodiment of an instrument stand according to the present invention.

FIG. 2 is a perspective view of an embodiment of an instrument stand according the present invention showing a detached neck bracket and detached support dowels.

FIG. 3 is a perspective view of an embodiment of the present invention, showing the reverse of the embodiment and the positioning of the piano-type hinge attaching the rear supports, which is not visible. It shows the leveling support on the upper stand, just above the neck cradle set screw attachment hole. Visible are the hook and loop installments allowing the rear support legs to attach and become immoveable when employed as repair station or wall display. Non-slip rubber bumper pads are shown that become the bottommost surfaces while in the horizontal position. Upper area shows the one set screw position used to attach the neck cradle.

FIG. 4 is a perspective view of an embodiment of a stand according to the invention, showing the stand in a prone position and further showing a stringed instrument thereon.

FIG. 5 is a perspective view of an optional wall mount bracket, according to an embodiment of this invention showing adjustable tightening wood screws that enable the bracket to accept the stand through the slots located on the main embodiment. It shows the pre-drilled holes that will enable the unit to be attached to a wall that employs wall anchors.

FIG. 6 is a perspective view of a wall mount bracket shown in FIG. 5 unassembled state.

FIG. 7 is a perspective view of an embodiment of a stand according to the invention showing the components therein and how it attaches to the pre-mounted wall bracket.

### DESCRIPTION OF THE PREFERRED EMBODIMENT

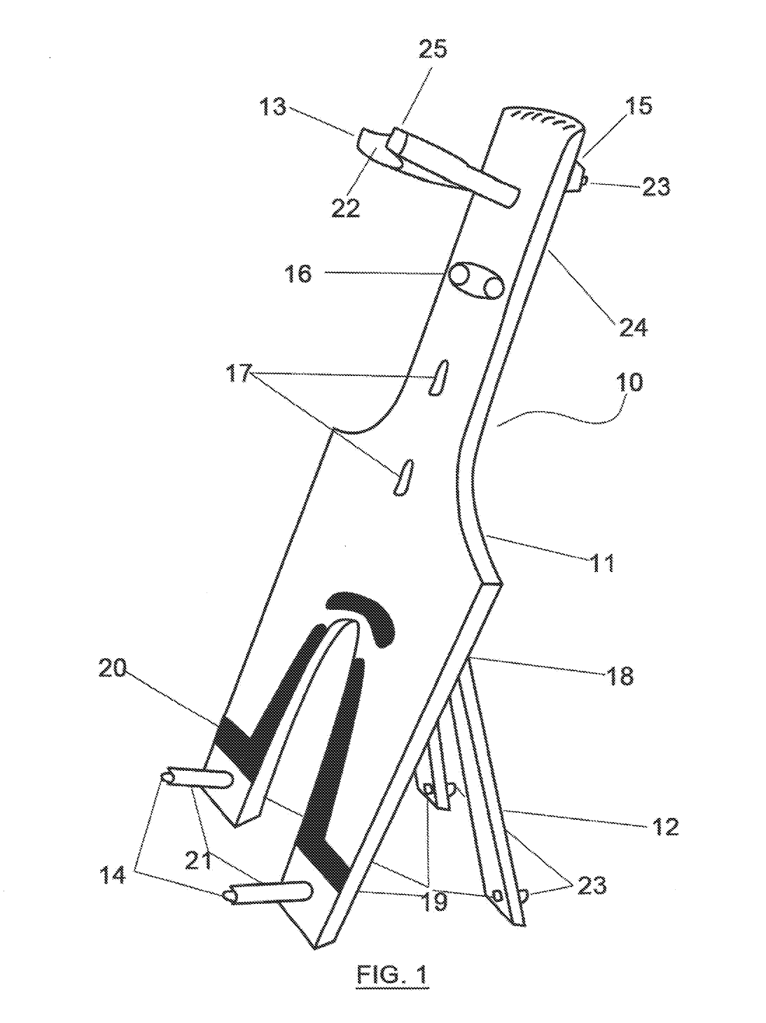

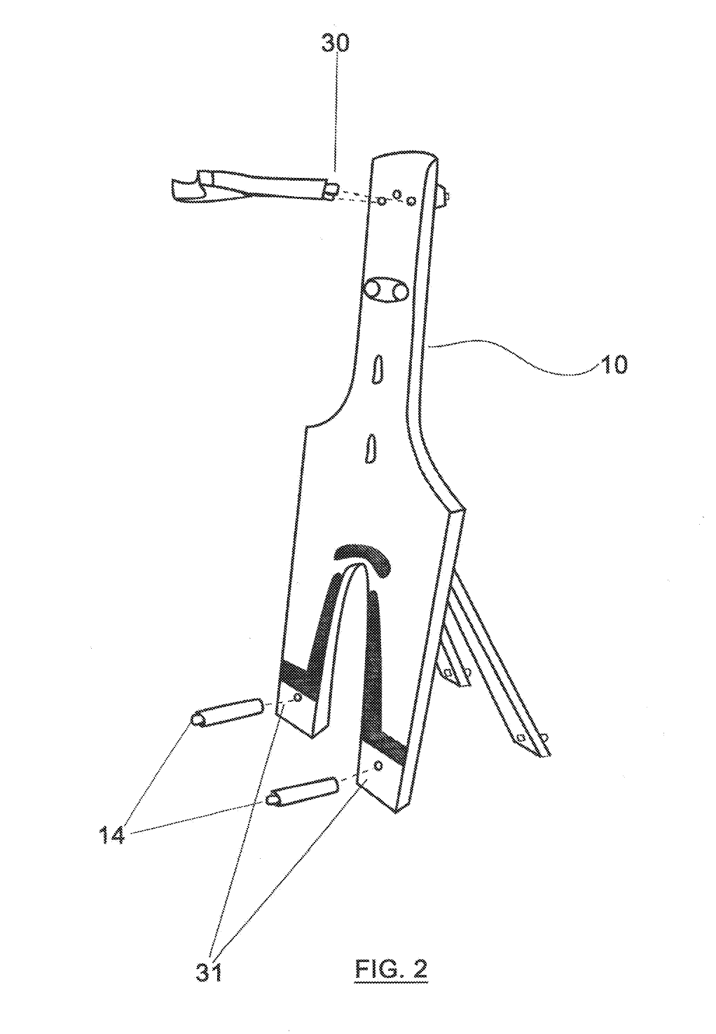

With reference to FIGS. 1 and 2, guitar stand 10 is provided that allows an instrument to be cradled gently but safely while not in use. A main body support 11 with dowel supports 14 and a u-shaped, padded bracket 13, having a curved opening on which the neck is rested. Folding rear support 12 is employed allowing the stand to tilt slightly to allow a three point support of an instrument. Alternatively, guitar stands may include a clamp of some locking device at the point of the neck support, holding the instrument in a more secure manner. The present invention employs simple elastic bands 16 that gently secures the neck portion of the instrument 25 to the neck cradle 13, to be used mainly while being employed as a wall display. The elastic bands are stored on the knob holders 16.

With reference to FIG. 1, the present invention embodiment includes stabilizer wood strip 15, used for leveling the support that equalizes in elevation with the folded rear support legs 12 while horizontal in the repair station position.

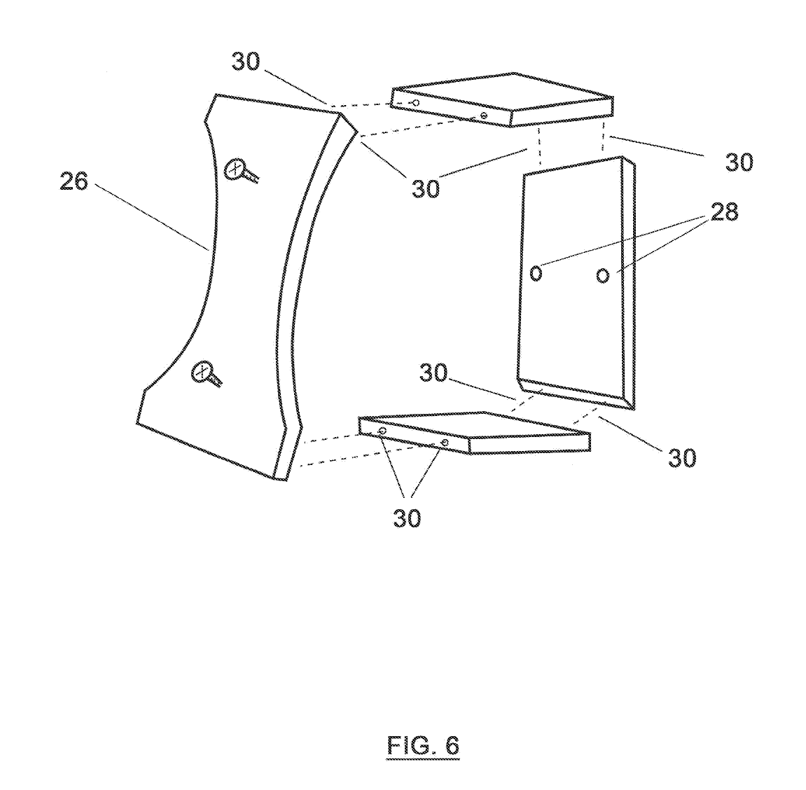

With reference to FIG. 1, located mid way up on the preferred embodiment main body support 11, are slots that enable the main body support, in it's entirety, to be attached to or hung on a wall mounted bracket, FIG. 6, 26. Additional features of the main body support include a piano-like hinge 18 that attaches the rear support legs 12. The piano-like hinge allows for the beveled upper ridge of the rear support legs to maintain the main body support and the desired angle of tilt required to efficiently maintain the instrument's stability.

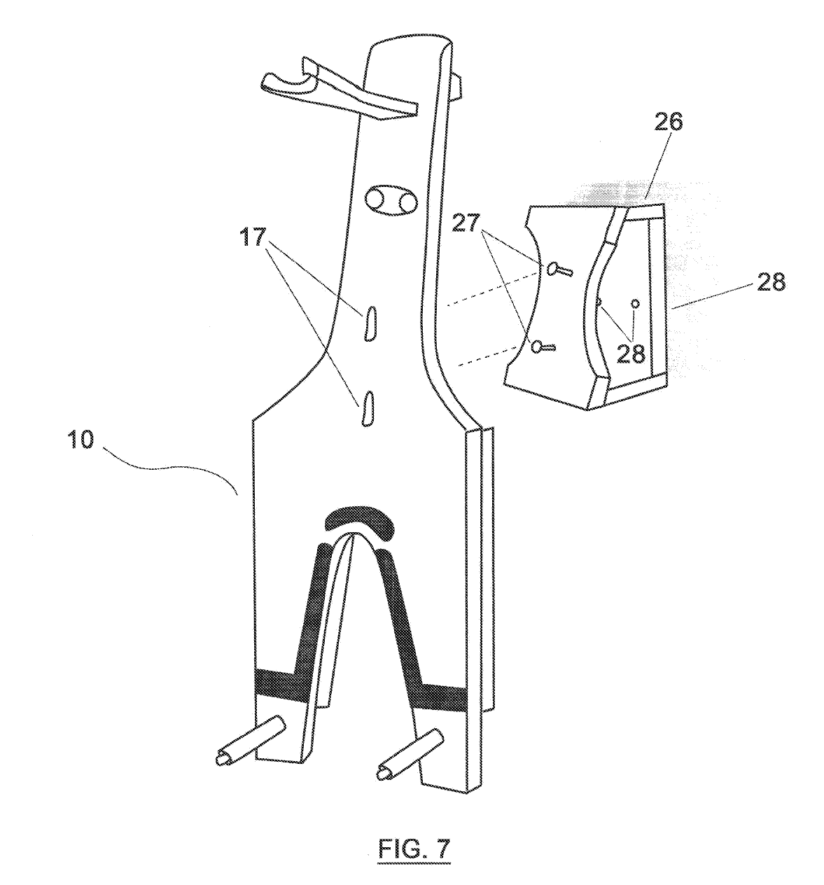

With reference to FIG. 1, another feature of the preferred embodiment main support body are hook and loop type placements 19 that facilitate securing the rear support legs 12 against the rear of the main body support when the stand is used as a repair station or when the stand is mounted on a wall, FIG. 7. Protective felt like padding 20 is employed on the main body support to protect the back surface of the stringed instrument. Clear rubber or plastic tubing 21 substantially covers the dowel supports 14, cushioning the bottommost portion of the instrument. Felt-like padding 22 lines the inner portion of neck cradle 13, which serves as protection for the neck portion of a stringed instrument.

With reference to FIG. 1, the upper portion of the main support body includes a removable set screw 24 that facilitates the quick removal of neck cradle 13, by a wingnut type or some other type of removable furniture set screw, for transport or storage.

With reference to FIG. 2, a preferred embodiment of the main support neck cradle attaches by a wingnut type or some other single removable furniture set screw aided by two unglued dowel alignments 30. Dowel supports 14 are also removable 31 and are unglued but tightly secured in pre-drilled holes.

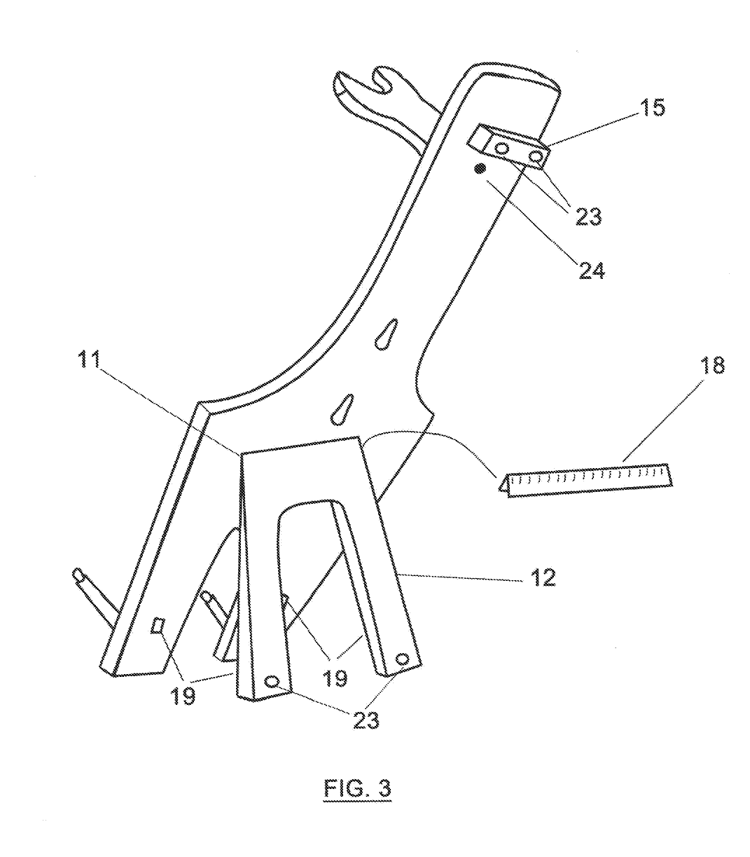

With reference to FIG. 3, the main support body shows a perspective rear view of the stand. A piano-like hinge 18 (in the area that could alternatively utilize a conventional hinge and slide bracket), by increasing or decreasing the angle that 12 makes with 11, that allows beveled upper edge of the rear support legs 12 to secure the proper tilt angle for the stand. The rear view perspective shows the rubber bumper 23 placements that allow for non-skid placement when employing the repair station position. The rear view perspective also shows the hook and loop placements 19 to be employed while in the repair station position or the wall display position.

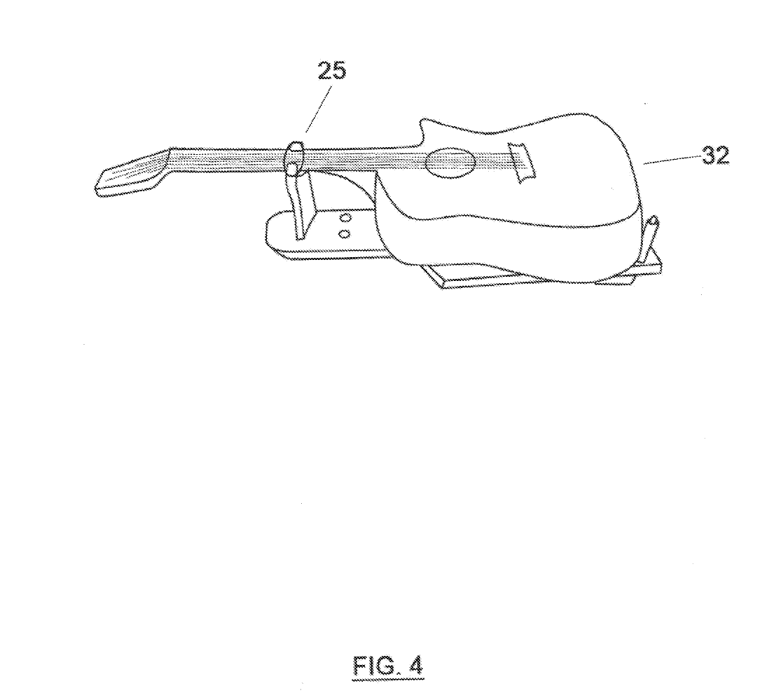

With reference to FIG. 4, main support body is shown in a repair station position. While in that position, main support body accepts a stringed instrument 32, for string changing, minor repairs or adjustments. If need be, less securing can be accomplished by placing elastic bands over neck and through the neck cradle slots 25. Securing at this point is not generally needed when changing strings.

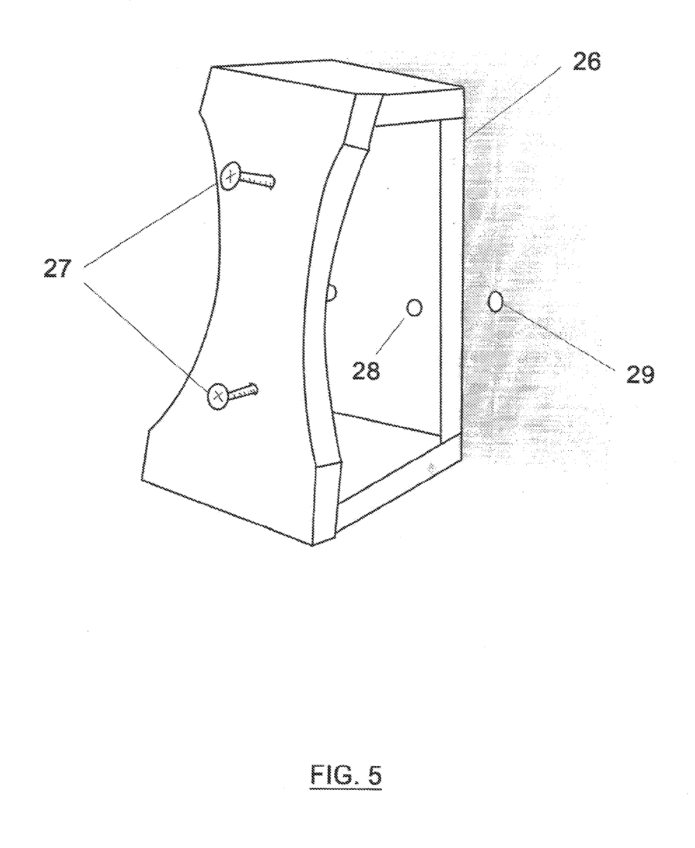

With reference to FIGS. 5 and 6, the separate wall bracket shows the positioning of wood screws 27 that serve as supports for the main support body attachment by slots 17 (FIG. 1). FIG. 6 also shows the positioning of the two holes 28, where screws will fasten wall bracket 26 to a wall by means of wall anchor 29. FIG. 6 also shows the separate unassembled portions of the wall mounting bracket. The wall bracket is assembled from the four portions and connected with dowels. Employing glue at the joints and dowels 30 will permanently assemble the wall bracket.

With reference to FIG. 7, it is shown how the main support body 10 attaches to the wall bracket 26, how wall bracket attaches to wall by pre drilled holes 28 and by anchors positioned in the wall to accept the wall bracket. The wall mounting need not be permanent by employing anchors that accept hand tightening wing nuts or screws.

The present invention has been described herein with regard to preferred embodiments. However, it will be obvious to persons skilled in the art that a number of variations and modifications can be made without departing from the scope of the invention as described herein.

### SUPPLEMENTAL SCHEDULE OF LEGEND

### Feature Number

10. The stand
11. Main body
12. Rear supports
13. Neck cradle
14. Dowel supports
15. Wood leveler strip
16. Wooden pull knobs for elastic band accessory
17. Slots for wall display attachment
18. ‘Piano-type’ hinge
19. Hook an loop attachment strips
20. Felt-like padding
21. Rubber tube padding
22. Felt-like neck cradle padding
23. Rubber bumpers
24. Allen screw system
25. Elastic band neck secure
26. Wall mount/display bracket
27. Adjustable screws for main body attachment
28. Drilled holes for wall attachment by screw system
29. Wall anchor for wall attachment by screw system
30. Bracket assembly by dowel system
31. Removable lower dowel feature
32. Guitar or stringed instrument in horizontal repair position

1. A stand (10) for a guitar or other stringed instrument comprising a main wood, plastic or metal support with neck cradle, support dowels and rear leg supports allowing slight tilting and gravitational resting of the instrument. The stand can be comprised of fine grained wood, stained and finished as a fine furniture item or crafted in plastic or metal. It can be produced in various colors and finishes.

2. A stand (10) according to claim 1, that contains rear movable supports allowing the stand to fold flat or prone, allowing level service surface from table top or floor surface.

3. A stand (10) according to claim 1, that attaches to a separate wall mount bracket that can be fastened to a wall for display.

4. A stand (10) according to claim 1, that disassembles by folding flat, removing neck support, and dowel supports for storage or transportation.

5. A stand (10) according to claim 1, that is refinished like fine furniture blending with decor in living areas or in appropriate finish for metal or plastic composition.

6. A stand (10) according to claim 2, that upon disassembly is conveniently transported to stage use as a stand or emergency repair station.

7. A stand (10) according to claim 3, can be attached to a mounted wall display bracket to free up studio or living area and eye level display and to reduce the chance of damage.

8. A four sided wooden wall mount bracket (26), that mounts to wall by screws and wall anchors.
